(19) United States
(12) Patent Application Publication
(10) Pub. No.: US 2007/0158320 A1
(43) Pub. Date: Jul. 12, 2007

(54) Laser machining apparatus

(75) Inventors: Chia-Lung Kuo, Yunlin County (TW); Bi-Nan Li, Taipei County (TW)

Correspondence Address: BACON & THOMAS, PLLC, 625 SLATERS LANE, FOURTH FLOOR, ALEXANDRIA, VA, 22314, US

(73) Assignee: Bing-Huan Lee, Kaohsiung County (TW)

(21) Appl. No.: 11/636,991

(22) Filed: Dec. 12, 2006

(30) Foreign Application Priority Data
Jan. 10, 2006 (TW) 95100962
Sep. 22, 2006 (TW) 95135226

(51) Int. Cl. B23K 26/14

(52) U.S. Cl. 219/121.84

(57) ABSTRACT

A laser machining apparatus includes a supply device, a recycle device, an operating device, and a laser device. The supply device is adapted for outputting a fluid. The recycle device is adapted for receiving the fluid. The operating device includes a first guide member and a second guide member. The first guide member communicates with the supply device. The second guide member communicates with the recycle device and has one end in communication with the first guide member. The laser device is adapted for generation of a laser beam passing through the operating device and projecting onto the workpiece. In light of this, the fluid flows into the first guide member after outputted from the supply device and then cooperates with the laser beam to machine the workpiece; finally, the fluid flows through the second guide member and then into the recycle device.

### BACKGROUND OF THE INVENTION

1. Field of the Invention

The present invention relates generally to machining apparatuses, and more particularly, to a machining apparatus employing laser and fluid auxiliary to cut and machine a workpiece.

2. Description of the Related Art

Referring to FIG. 1, a conventional machining apparatus is operated to cut a workpiece 2 to predetermined size by translocating where so-called water-jet cutter formed by a high-pressure guided spout 1 impacts.

However, the conventional machining apparatus employs the open high-pressure spout 1 for machining to easily splash the liquid of the spout 1 onto the workpiece 2 while machining the workpiece 2; while machining the workpiece 2 is accomplished, it still needs to proceed to the cleaning and drying treatment procedures; thus it takes much more working-hours and higher production cost. Further, the splashed liquid likely carries the chippings 3 produced while the workpiece 2 are cut/machined to damage the workpiece 2. In addition, if a protective film is covered on the workpiece 2 before machining the workpiece 2 and then removed after the machining is done, it may though prevent the chippings 3 from damage to the workpiece 2, but it will complicate the machining process and increase the production cost.

### SUMMARY OF THE INVENTION

The primary objective of the present invention is to provide a laser machining apparatus which employs the laser and the fluid for machining to enhance machine rate.

The secondary objective of the present invention is to provide a laser machining apparatus which employs a backflow tunnel for recycling the fluid and the chippings to prevent the fluid and the chippings from splash and scattering respectively to further protect the workpiece from damage.

The foregoing objectives of the present invention are attained by the laser machining apparatus composed of a supply device, a recycle device, an operating device, and a laser device. The supply device is adapted for outputting a fluid. The recycle device is adapted for receiving the fluid. The operating device includes a first guide member and a second guide member. The first guide member communicates with the supply device. The second guide member communicates with the recycle device and has one end in communication with the first guide member. The laser device is adapted for generation of a laser beam passing through the operating device and projecting onto the workpiece. In light of this, the fluid flows into the first guide member after outputted from the supply device and then cooperates with the laser beam to machine the workpiece; finally, the fluid flows through the second guide member and then into the recycle device.

### BRIEF DESCRIPTION OF THE DRAWINGS

FIG. 1 is a schematic view of the prior art in operation.

FIG. 2 is a perspective view of a first preferred embodiment of the present invention.

FIG. 3 is a schematic structural view of the first preferred embodiment of the present invention.

FIG. 4 is a partial enlarged perspective view of the first preferred embodiment of the present invention.

FIG. 5 is a schematic structural view of a second preferred embodiment of the present invention.

FIG. 6 is a schematic structural view of a third preferred embodiment of the present invention.

FIG. 7 is a partial enlarged perspective view of a fourth preferred embodiment of the present invention.

FIG. 8 is a partial enlarged perspective view of a fifth preferred embodiment of the present invention.

FIG. 9 is a schematic structural view of a sixth preferred embodiment of the present invention.

### DETAILED DESCRIPTION OF PREFERRED EMBODIMENTS

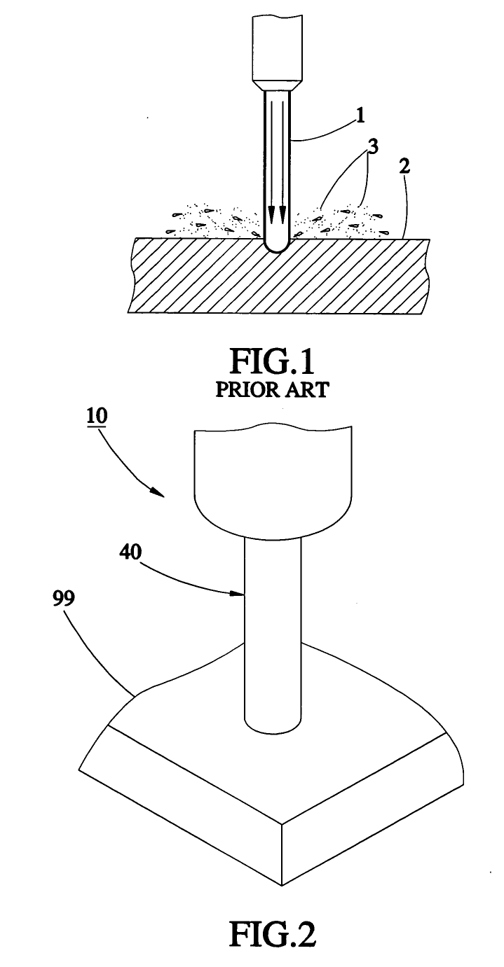

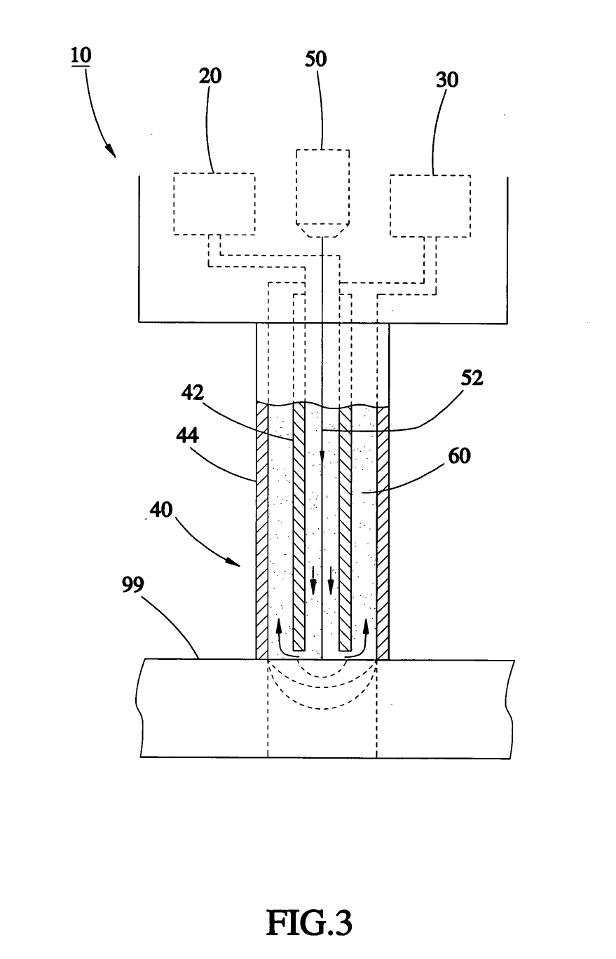

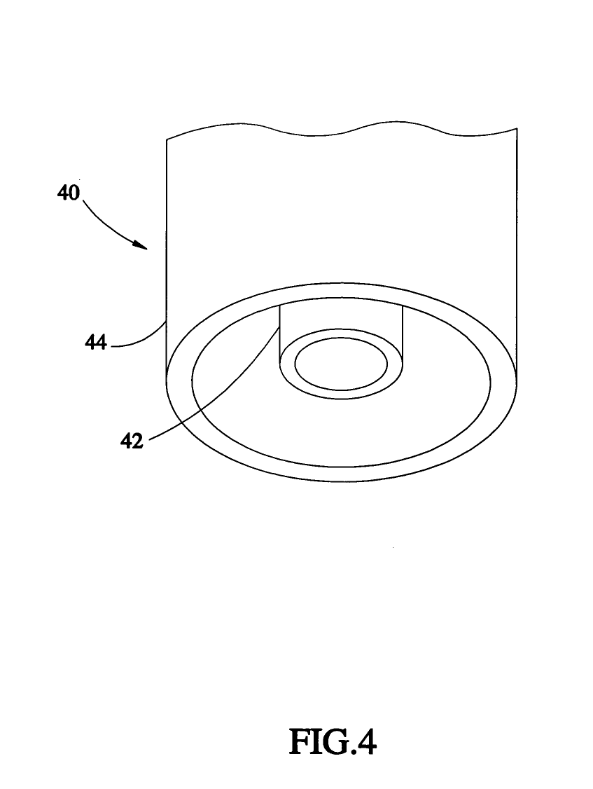

Referring to FIGS. 2-4, a laser machining apparatus 10, constructed according to a first preferred embodiment of the present invention, for machining a workpiece 99 is composed of a supply device 20, a recycle device 30, an operating device 40, and a laser device 50.

The supply device 20 is adapted for outputting a fluid 60. The fluid 60 is the air, oxygen, carbon oxide, carbon dioxide, nitrogen, an inertial gas, water, or a chemical liquid, wherein chemical liquid is sulfuric acid, hydrochloric acid, sodium nitrate, salt compound, sodium hydroxide, potassium hydroxide, or hydrofluoric acid. In this embodiment, the fluid 60 is the hydrochloric acid.

The recycle device 30 is adapted for receiving the fluid 60 flowing through the operating device 40 and the workpiece 99.

The operating device 40 includes a first guide member 42 and a second guide member 44. The first and second guide members 42 and 44 are tubular. The first guide member 42 is located in the second guide member 44 and in communication with the supply device 20, for guiding the fluid 60 to flow to the workpiece 99. The second guide member 44 communicates with the recycle device 30 and has an end on communication with the first guide member 42 for guiding the fluid 60 to flow into the recycle device 30.

The laser device 50 is adapted for generation of a laser beam 52 passing through an inner side of the first guide member 42 of the operating device 40 and projecting onto the workpiece 99.

In light of the above structure, when the laser machining apparatus 10 works on the workpiece 99, the laser beam 52 directly machines the workpiece 99 by means of heat energy. In the meantime, the fluid 60 flows downward to a bottom end of the guide member 42 from the supply device 20 to contact the workpiece 99 and to further erode the machined part of the workpiece 99, thus enhancing the machining speed. As the machining proceeds, the concentration of the fluid 60 reduces gradually and the workpiece 99 produces chippings. Through the attraction of the recycle device 30 and the guidance of the second guide member 44, the fluid 60 carries the chippings to flow upward to the recycle device 30 from a bottom end of the second guide member 44. In the meantime, the supply device 20 keeps outputting the fluid 60 to the first guide member 42 to maintain constant flow and concentration of the fluid 60 located in the operating device 40.

In light of the above, the laser machining apparatus 10 of the present invention employs the laser beam 52 and the fluid 60 to machine the workpiece 99 to enhance the machining speed. Further, the present invention structurally employs the design of backflow tunnel for recycling the fluid 60 and the chippings of the workpiece 99 to prevent the fluid 60 and the chippings from splash and scattering respectively, thus protecting the workpiece 99 from damage.

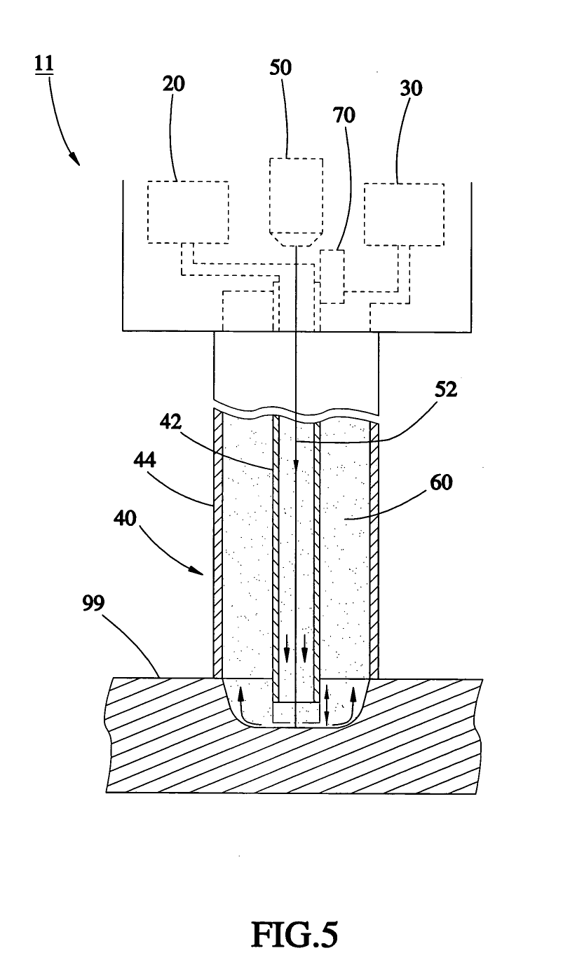

Referring to FIG. 5, a laser machining apparatus 11, constructed according to a second preferred embodiment of the present invention, is similar to that of the first embodiment but different in that the laser machining apparatus 11 further includes an elevating device 70 mounted to the first guide member 42 for driving the first guide member 42 to move with respect to the workpiece 99, thus further controlling the machining range of the fluid 60 to enhance the machining effect.

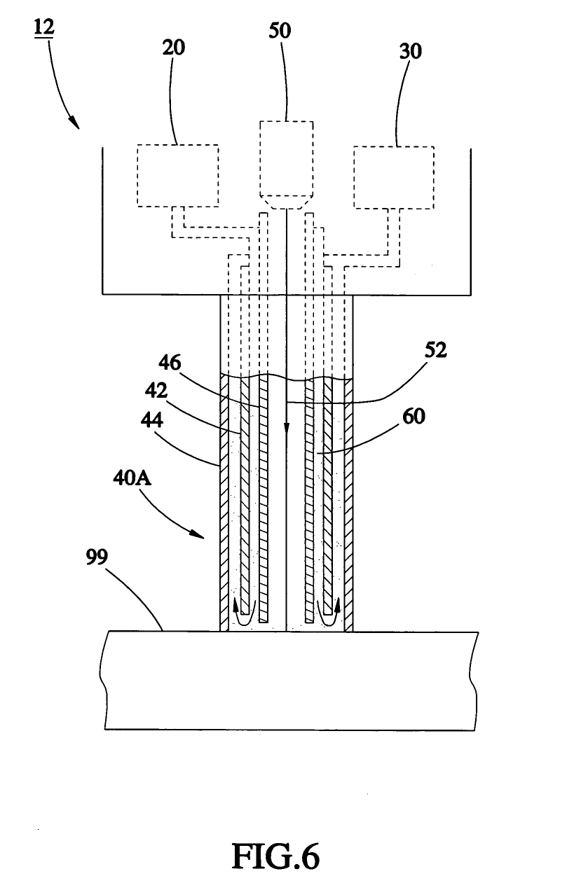

Referring to FIG. 6, a laser machining apparatus 12, constructed according to a third preferred embodiment of the present invention, is similar to that of the first embodiment but different in that the operating device 40A further includes a tubular inner guide member 46 located in the first guide member 42 for passing therethrough by the laser beam 52. The inner guide member 46 and the first guide member 42 are spaced from each other for a predetermined interval, through which the fluid 60 can pass and then flow to the workpiece 99.

In light of the above structure, when the laser machining apparatus 10 works on the workpiece 99, the laser beam 52 passes through an inner side of the inner guide member 46 and directly machines the workpiece 99; meanwhile, the fluid 60 is outputted from the supply device 20 and then flows downward to between the first and inner guide members 42 and 46 to contact the workpiece 99. Finally, the fluid 60 is attracted by the recycle device 30 and then guided by the second guide member 44 to flow to the recycle device.

Accordingly, the laser beam 52 and the fluid 60 employs the respect tunnels to achieve the same effect and further reduce the influence of the fluid 60 on the laser beam 52, thus enhancing the stability of the machining effect.

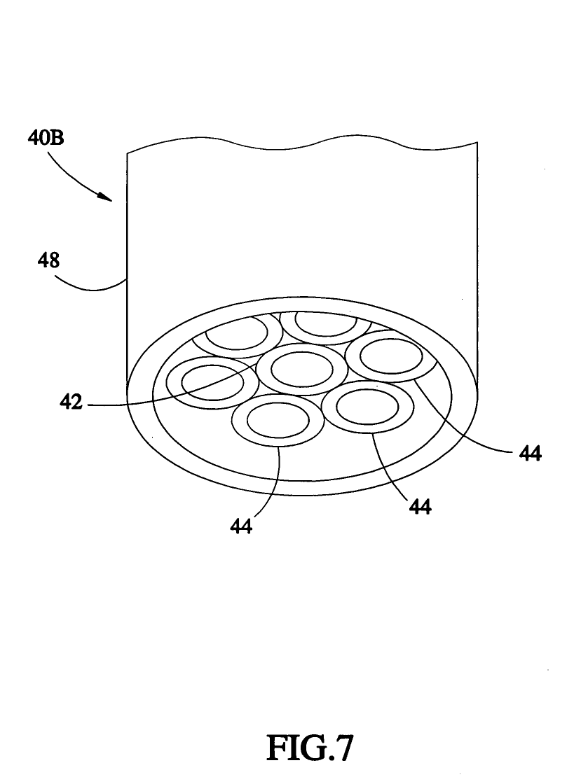

Referring to FIG. 7, a laser machining apparatus (not shown), constructed according to a fourth preferred embodiment of the present invention, is similar to that of the first embodiment but different in that the operating device 40B further includes a tubular outer tube 48, and there are more than one second guide members 44 arranged around the first guide member 42. The first and second guide members 42 and 44 are located in the outer tube 48 for passing through by the laser beam (not shown). The outer tube 48 and the first guide member 42 are spaced from each other for a predetermined interval which allows the fluid (not shown) to pass therethrough and then to flow to the workpiece (not shown). Accordingly, the fourth embodiment can reach the same effect as the first embodiment.

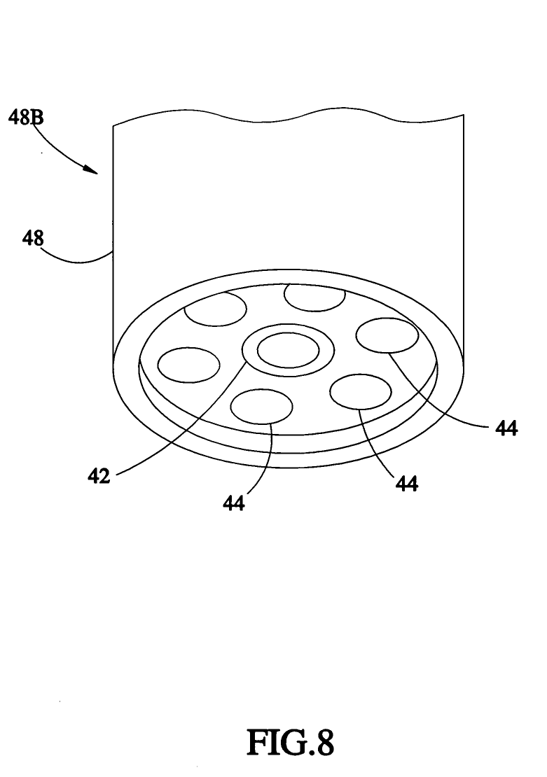

Referring to FIG. 8, a laser machining apparatus (not shown), constructed according to a fifth preferred embodiment of the present invention, is similar to that of the fourth embodiment but different in providing an alternative example.

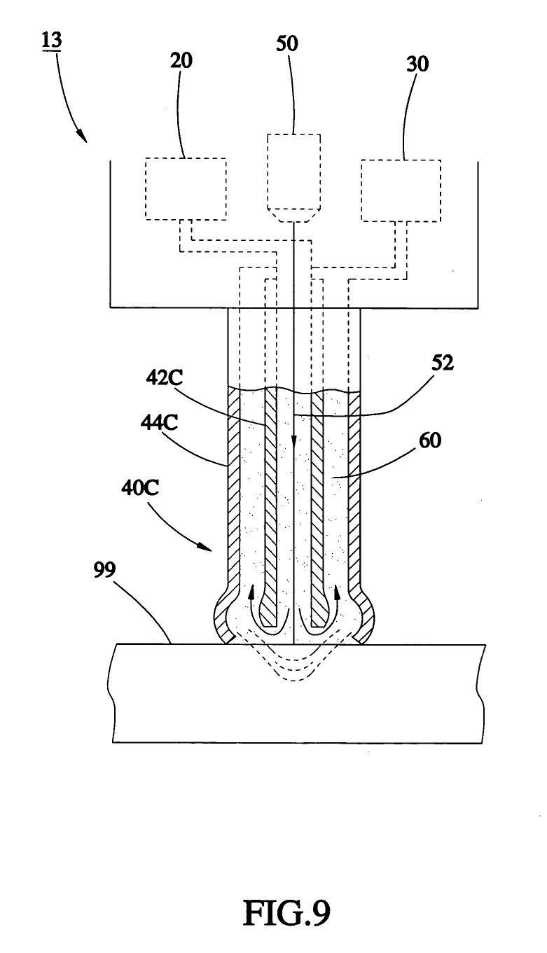

Referring to FIG. 9, a laser machining apparatus 13, constructed according to a sixth preferred embodiment of the present invention, is similar to that of the first embodiment but different in that the operating device 40C includes a first guide member 42C and a second guide member 44C. Each of the first and second guide members 42C and 44C has a lower part located close to the workpiece and expanding slightly outward for limiting the machining range of the fluid 60.

In conclusion, the laser machining apparatus of the present invention employs the laser and fluid to machine the workpiece at the same time to enhance the machining speed and to effectively control the machining range, thus ensuring the quality of the machining. Further, the present invention structurally employs the backflow design to prevent the fluid and the chippings from splash and scattering, thus protecting the workpiece from damage. In addition, the present invention simplifies the machining process to have advantages of reducing the working-hours and production cost.

Although the present invention has been described with respect to specific preferred embodiments thereof, it is no way limited to the details of the illustrated structures but changes and modifications may be made within the scope of the appended claims.

What is claimed is:

1. A laser machining apparatus capable of machining a workpiece, comprising:
a supply device for outputting a fluid;
a recycle device for receiving said fluid
an operating device having a first guide member and a second guide member, said first guide member in communication with said supply device, said second guide member in communication with said recycle device and having an end thereof in communication with said first guide member; and
a laser device for generating a laser beam passing through said operating device and projecting on said workpiece;
whereby said fluid flows into said first guide member from said supply device to machine said workpiece together with said laser beam, and finally flows to said recycle device through said second guide member.

2. The laser machining apparatus as defined in claim 1, wherein said first and second guide members are tubular, said first guide member being located in said second guide member; said laser beam can pass through an inner side of said first guide member.

3. The laser machining apparatus as defined in claim 2, wherein said operating device further comprises a tubular inner guide member located in said first guide member for passing through by said laser beam, said inner guide member and said first guide member being spaced from each other for a predetermined interval allowing said fluid to pass therethrough.

4. The laser machining apparatus as defined in claim 3, wherein said operating device further comprises an elevating device for driving one of said first, second, and inner guide members to move with respect to said workpiece.

5. The laser machining apparatus as defined in claim 2, wherein said operating device further comprises an outer tube; said first and second guide members are located in said outer tube.

6. The laser machining apparatus as defined in claim 5, wherein said operating device further comprises a plurality of said second guide members located around said first guide member.

7. The laser machining apparatus as defined in claim 5, wherein said outer tube has a part located close to said workpiece and expanding slightly outward.

8. The laser machining apparatus as defined in claim 1, wherein at least one of said first and second guide members has a part located close to said workpiece and expanding slightly outward.

9. The laser machining apparatus as defined in claim 1, wherein said fluid is the air, oxygen, carbon oxide, carbon dioxide, nitrogen, an inertial gas, water, or a chemical liquid selected from the group consisting of sulfuric acid, hydrochloric acid, sodium nitrate, salt compound, sodium hydroxide, potassium hydroxide, and hydrofluoric acid.
